(19) United States
(12) Patent Application Publication
(10) Pub. No.: US 2026/0067568 A1
(43) Pub. Date: Mar. 5, 2026

(54) Intelligent Focus Adjustment of a Variable Focus Imaging Assembly

(71) Applicant: ZEBRA TECHNOLOGIES CORPORATION, Lincolnshire, IL (US)

(72) Inventors: Yuri Astvatsaturov, Lake Forest, IL (US); Miroslav Trajkovic, Setauket, NY (US); Justin F. Barish, Kings Park, NY (US)

(21) Appl. No.: 18/821,160

(22) Filed: Aug. 30, 2024

(51) Int. Cl. H04N 23/67; G06T 7/40; G06T 7/50; G06T 7/77; G06T 7/80

(52) U.S. Cl. CPC H04N 23/673; G06T 7/50; G06T 7/77; G06T 7/80; G06T 7/40; G06T 2207/10028

(57) ABSTRACT

A device may include an imaging assembly including a depth camera and configured to capture depth image data of one or more objects appearing in a field of view (FOV). A device may cause the one or more processors to: capture, via the imaging assembly, the depth image data of the one or more objects appearing in the FOV, detect one or more candidate objects of the one or more objects appearing in the FOV, generate a ranking of the one or more candidate objects based on at least a candidate distance for the each candidate object of the one or more candidate objects; and automatically determine an initial focus value based on the ranking of the one or more candidate objects.

### BACKGROUND

Determining a focus value of an imaging assembly (e.g., a scanner) can pose significant challenges. Current techniques may function via the imaging assembly estimating the distance of an object by observing the shift in the position of an aiming dot (e.g., laterally) as seen from different perspectives. The imaging assembly may then utilize such a shift (e.g., via parallax), to estimate the object's distance. The imaging assembly may then use the estimated distance to determine the focus value of the imaging assembly. Such methods can result in inaccuracies. For example, the scanner may focus on words listed on an object instead of focusing on a barcode of the object. Moreover, issues such as misalignment of an aim dot of the imaging assembly, inability to capture image data relevant to the aim dot, and/or extended cycling through ramping profiles often contribute to inefficiencies in the overall operation of the scanner and/or system. These challenges lead not only to delay in decoding processes, but also diminish overall productivity. A better and more efficient method to determine the focus value of the imaging assembly is needed.

### SUMMARY

In some aspects, the techniques described herein relate to an imaging device configured to determine an initial focus value, the imaging device including: one or more processors; an imaging assembly including a depth camera and configured to capture depth image data of one or more objects appearing in a field of view (FOV); and a computer-readable medium storing machine readable instructions that, when executed, cause the one or more processors to: capture, via the imaging assembly, the depth image data of the one or more objects appearing in the FOV; detect one or more candidate objects of the one or more objects appearing in the FOV, each candidate object of the one or more candidate objects being associated with a candidate distance; generate a ranking of the one or more candidate objects based on at least the candidate distance for the each candidate object of the one or more candidate objects, the ranking indicative of a focus target likelihood for the each candidate object of the one or more candidate objects; and automatically determine the initial focus value based on the ranking of the one or more candidate objects.

In some aspects, the techniques described herein relate to an imaging device, wherein automatically determining the initial focus value is further based on a highest ranked candidate object.

In some aspects, the techniques described herein relate to an imaging device, wherein the computer-readable medium further stores additional instructions that, when executed, cause the imaging device to: determine that the highest ranked candidate object is not a target object; and automatically generate an updated ranking of the one or more candidate objects based on a remaining subset of the one or more candidate objects, wherein the remaining subset excludes the highest ranked candidate object.

In some aspects, the techniques described herein relate to an imaging device, wherein generating the updated ranking is based at least on a focus delta value indicative of a difference between the initial focus value and a subsequent focus value.

In some aspects, the techniques described herein relate to an imaging device, wherein the automatically generating the updated ranking is constrained by a predetermined time limit or a maximum number of redeterminations.

In some aspects, the techniques described herein relate to an imaging device, wherein the computer-readable medium further stores additional instructions that, when executed, cause the imaging device to: calculate one or more candidate scores of the one or more candidate objects.

In some aspects, the techniques described herein relate to an imaging device, wherein the ranking of the one or more candidate objects is further based on the one or more candidate scores of the one or more candidate objects.

In some aspects, the techniques described herein relate to an imaging device, wherein the computer-readable medium further stores additional instructions that, when executed, cause the imaging device to: convert the depth image data to a point cloud; identify one or more planar regions of the one or more objects using a planar segmentation algorithm; and determine a planar determination representative of an object surface for an object of the one or more objects based on the one or more planar regions.

In some aspects, the techniques described herein relate to an imaging device, wherein the ranking of the one or more candidate objects is further based on the planar determination of the one or more candidate objects.

In some aspects, the techniques described herein relate to an imaging device, wherein the ranking of the one or more candidate objects is further based on directionalities of the one or more candidate objects representative of a direction an object is facing relative to the imaging device.

In some aspects, the techniques described herein relate to an imaging device, wherein the ranking of the one or more candidate objects is further based on position of the one or more candidate objects.

In some aspects, the techniques described herein relate to an imaging device, wherein the ranking of the one or more candidate objects is further based on an intersection between an aiming line and the one or more candidate objects.

In some aspects, the techniques described herein relate to an imaging device, wherein the ranking of the one or more candidate objects is further based on contrast from the depth image data of the one or more candidate objects.

In some aspects, the techniques described herein relate to an imaging device, further including a two dimensional (2D) autofocus imaging assembly configured to: capture, via the 2D autofocus imaging assembly, 2D image data of the one or more objects.

In some aspects, the techniques described herein relate to an imaging device, wherein the computer-readable medium further stores additional instructions that, when executed, cause the imaging device to: calibrate one or more metrics of the FOV, at least some of the one or more metrics representative of positions of the one or more objects appearing in the FOV, based on the 2D image data and the depth image data to generate one or more calibrated metrics.

In some aspects, the techniques described herein relate to an imaging device, wherein the candidate distance for the each candidate object of the one or more candidate objects is determined based on the one or more calibrated metrics.

In some aspects, the techniques described herein relate to a method for determining an initial focus value of an imaging device, the method including: capturing, by one or more processors via an imaging assembly, a depth image data of one or more objects appearing in a field of view (FOV); detecting, by the one or more processors, one or more candidate objects of the one or more objects appearing in the FOV, each candidate object of the one or more candidate objects being associated with a candidate distance; generating, by the one or more processors, a ranking of the one or more candidate objects based on at least the candidate distance for the each candidate object of the one or more candidate objects, the ranking indicative of a focus target likelihood for the each candidate object of the one or more candidate objects; and automatically determining, by the one or more processors, the initial focus value based on the ranking of the one or more candidate objects.

In some aspects, the techniques described herein relate to a method, wherein automatically determining the initial focus value is further based on a highest ranked candidate object.

In some aspects, the techniques described herein relate to a method, wherein the method further includes: determining, by the one or more processors, that the highest ranked candidate object is not a target object; and automatically generating, by the one or more processors, an updated ranking of the one or more candidate objects based on a remaining subset of the one or more candidate objects, wherein the remaining subset excludes the highest ranked candidate object.

In some aspects, the techniques described herein relate to a method, wherein generating the updated ranking is based at least on a focus delta value indicative of a difference between the initial focus value and a subsequent focus value.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A illustrates a front perspective view of a first example handheld barcode reader;

FIG. 1B illustrates a back perspective view of the handheld barcode reader of FIG. 1A;

FIG. 2 illustrates a block diagram of an example imaging device such as the example handheld barcode reader of FIG. 1A;

FIG. 3A illustrates a perspective view of the handheld barcode reader of FIG. 1A determining an initial focus value.

FIG. 3B illustrates a perspective view of the handheld barcode reader of FIG. 1A determining a subsequent focus value.

FIG. 4 illustrates a flow diagram of an example method for determining an initial focus value, to be implemented in an imaging device such as the handheld barcode reader of FIG. 1A;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The example imaging devices disclosed herein utilize a depth camera (e.g., an imaging sensor that records and/or measures depth in an imaging assembly of an imaging device) to capture depth image data of one or more objects appearing in a field of view (FOV). The depth image data provides the imaging device with distance information of the one or more objects. The imaging device can then utilize the distance information provided by the depth image data to determine a more accurate initial focus value. Additionally, the determination of the initial focus value is made more efficient, as the imaging device no longer needs to estimate the distance of the object using the aiming dot.

Further, the imaging device can utilize different aspects of the one or more objects to accurately determine the initial focus value. For example, the imaging device can account for directionalities of the one or more objects, positions of the one or more objects, intersection between the aiming line and the one or more objects, and/or contrast from the depth image data of the one or more objects to determine the initial focus value. By utilizing these different aspects in determining the initial focus value along with the distance information, the imaging device can determine an even more accurate initial focus value. Additionally, in determining an initial focus value, the imaging device is able to properly focus on objects that may otherwise cause problems using traditional aiming light-focused techniques (e.g., objects with reflective surfaces) and/or properly focus on objects even where aiming light-focused techniques may otherwise fail (e.g., where the aiming light moves and/or partially illuminates another surface at a different distance). It will be understood that, depending on the implementation, the techniques described herein may be used in addition to and/or in place of aiming light-focused techniques, as described in more detail below.

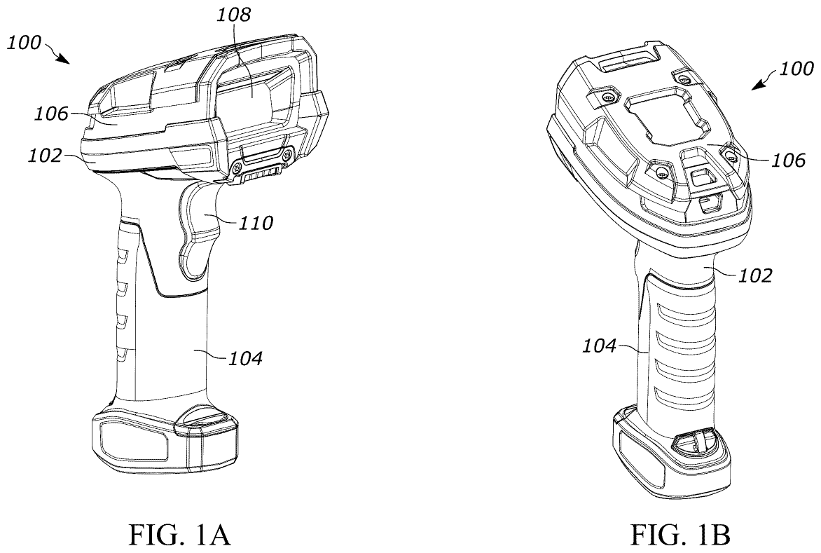

Referring to FIGS. 1A and 1B, FIGS. 1A and 1B illustrate an exemplary handheld imaging device 100 having a housing 102 with a handle portion 104, also referred to as a handle 104, and a head portion 106, also referred to as a scanning head 106. The head portion 106 includes a window 108 and is configured to be positioned on the top of the handle portion 104. The handle portion 104 is configured to be gripped by a reader user and includes a trigger 110 for activation by the user. Optionally included in an embodiment is also a base (not shown), also referred to as a base portion, that may be attached to the handle portion 104 opposite the head portion 106, and is configured to stand on a surface and support the housing 102 in a generally upright position. The handheld imaging device 100 can be used in a hands-free mode as a stationary workstation when it is placed on a countertop or other workstation surface. The handheld imaging device 100 can also be used in a handheld mode when it is picked up off the countertop or base station, and held in an operator's hand. In the hands-free mode, products can be slid, swiped past, or presented to the window 108 for the reader to initiate barcode reading operations. In the handheld mode, the handheld imaging device 100 can be moved towards a barcode on a product, and the trigger 110 can be manually depressed to initiate imaging of the barcode.

Other implementations may provide only handheld or only hands-free configurations. In the embodiment of FIGS. 1A-1B, the handheld imaging device 100 is ergonomically configured for a user's hand, though other configurations may be utilized as understood by those of ordinary skill in the art. As shown, the handle portion 104 extends below and rearwardly away from the housing 102 along a centroidal axis obliquely angled relative to a central FOV axis of a FOV of an imaging assembly within the scanning head 106.

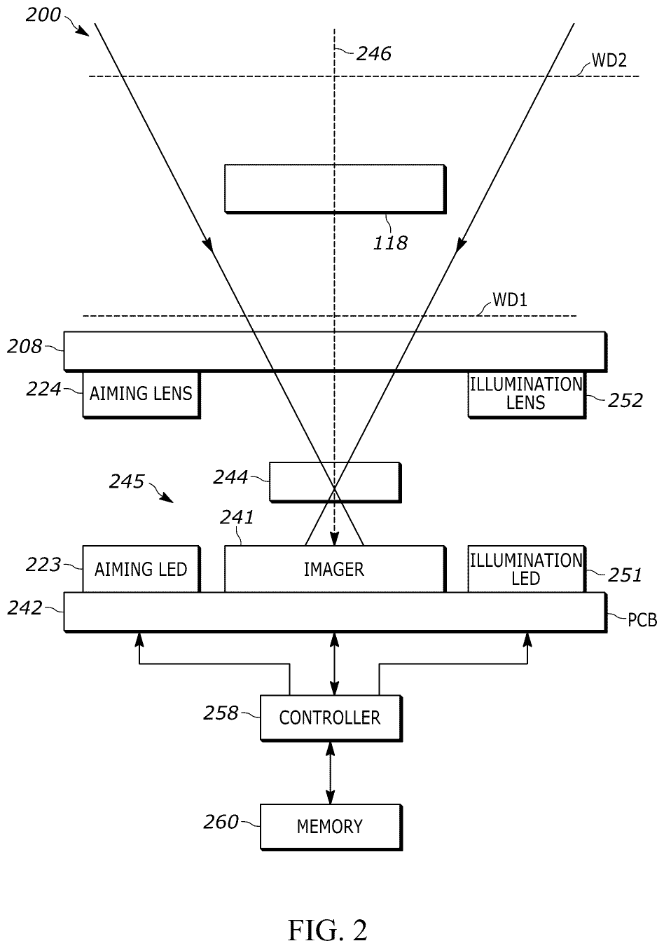

In some embodiments, an imaging assembly includes a light-detecting sensor or imager operatively coupled to, or mounted on, a printed circuit board (PCB) in the handheld imaging device 100 as shown in FIG. 2. In further embodiments, an illuminating light assembly is also mounted in the handheld imaging device 100. The illuminating light assembly may include an illumination light source and at least one illumination lens, configured to generate a substantially uniform distributed illumination pattern of illumination light on and along an object to be read by image capture, as described below with regard to FIG. 2.

Referring next to FIG. 2, a block diagram of an example architecture for an imaging device such as handheld imaging device 100 is shown. For at least some of the reader implementations, an imaging assembly 245 includes a light-detecting sensor or imager 241 operatively coupled to, or mounted on, a printed circuit board (PCB) 242 in the imaging device 200 as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging assembly 245 over a field of view along an imaging axis 246 through the window 208. The imager 241 may also include and/or function as a monochrome sensor and, in further implementations, a color sensor. It should be understood that the terms “imager”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

In some embodiments, the imaging assembly 245 may include a depth camera. The depth camera can capture both the visual appearance and the distance of objects in a scene, providing a 3D representation of the environment. The depth camera can use technologies such as Time-of-Flight (ToF), structured light, or stereo vision to measure the distance between the camera and each point in the scene. Each captured depth image includes depth information for every pixel, allowing for precise spatial analysis and object recognition.

A depth image can comprise a depth map that encodes the distance information of objects from the camera. Each pixel in the depth map can represent the distance between the camera and a point in the scene. Unlike conventional 2D images that capture color and brightness, the depth map can provide a third dimension of information (e.g., distance), allowing for the creation of 3D representations of the environment.

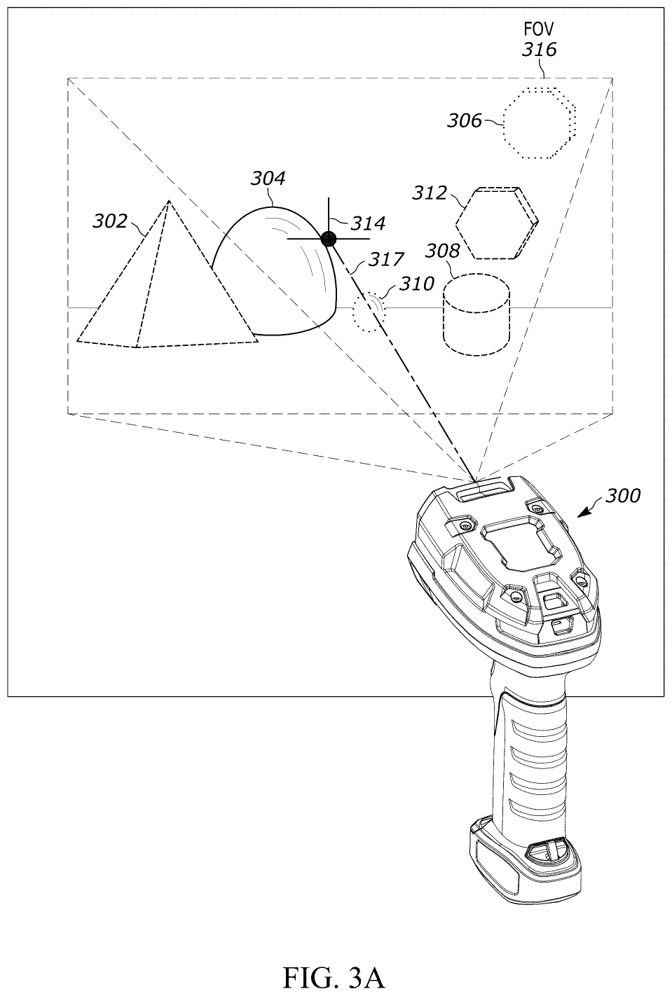

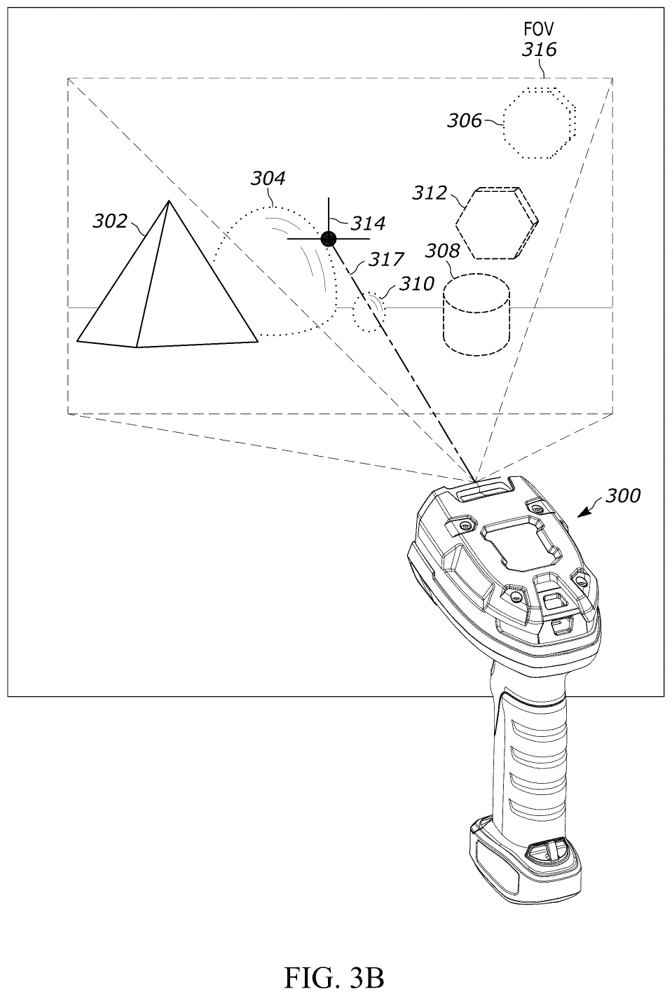

In further embodiments, the imaging assembly 245 may comprise an application-specific integrated circuit (ASIC) that can determine contrast of the depth image in real-time. For example, the ASIC can determine in real-time that objects such as a barcode has a high contrast while objects such as plain wall (with uniform surface area) has a small contrast. The imaging device 200 may use the contrast information of the depth image to determine a focus value, as described below with regard to FIGS. 3A and 3B.

In some other embodiments, the imaging device 200 may comprise one or more imaging assemblies. For example, the imaging device 200 may have 2D autofocus imaging assembly for capturing conventional 2D imaging data, and may have depth camera imaging assembly that can capture 3D imaging data (depth image data). The imaging device 200 may use both the conventional 2D imaging data and the 3D imaging data when determining a focus value.

The return light is scattered and/or reflected from an object 118 over the field of view. The imaging lens 244 is operative for focusing the return light onto the array of image sensors to enable the object 118 to be imaged. In particular, the light that impinges on the pixels is sensed and the output of those pixels produce image data that is associated with the environment that appears within the FOV (which can include the object 118). This image data is typically processed by a controller (usually by being sent to a decoder) which identifies and decodes decodable indicia captured in the image data. Once the decode is performed successfully, the reader can signal a successful “read” of the object 118 (e.g., a barcode). The object 118 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly may also be mounted in, attached to, or associated with the imaging device 200. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 118 to be imaged by image capture. Although FIG. 2 illustrates a single illumination light source 251, it will be understood that the illumination light source 251 may include more light sources. At least part of the scattered and/or reflected return light is derived from the illumination pattern of light on and along the object 118.

An aiming light assembly may also be mounted in, attached to, or associated with the imaging device 200 and preferably includes an aiming light source 223, e.g., one or more aiming LEDs or laser light sources, and an aiming lens 224 for generating and directing a visible aiming light beam away from the imaging device 200 onto the object 118 in the direction of the FOV of the imager 241. It will be understood that, although the aiming light assembly and the illumination light assembly both provide light, an aiming light assembly differs from the illumination light assembly at least in the type of light the component provides. For example, the illumination light assembly provides diffuse light to sufficiently illuminate an object 118 and/or an indicia of the object 118 (e.g., for image capture). An aiming light assembly instead provides a defined illumination pattern (e.g., to assist a user in visualizing some portion of the FOV). Similarly, in some implementations, the illumination light source 251 and the aiming light source 223 are active at different, non-overlapping times. For example, the illumination light source 251 may be active on frames when image data is being captured and the aiming light source 223 may be active on frames when image data is not being captured (e.g., to avoid interference with the content of the image data).

Further, the imager 241, the illumination source 251, and the aiming source 223 are operatively connected to a controller or programmed controller 258 (e.g., a microprocessor facilitating operations of the other components of imaging device 200) operative for controlling the operation of these components. In some implementations, the controller 258 functions as or is communicatively coupled to a vision application processor for receiving, processing, and/or analyzing the image data captured by the imager 241.

A memory 160 is connected and accessible to the controller 258. Preferably, the controller 258 is the same as the one used for processing the captured return light from the illuminated object 118 to obtain data related to the object 118. Though not shown, additional optical elements, such as collimators, lenses, apertures, compartment walls, etc. may be provided in the housing. Although FIG. 2 shows the imager 241, the illumination source 251, and the aiming source 223 as being mounted on the same PCB 242, it should be understood that different implementations of the imaging device 200 may have these components each on a separate PCB, or in different combinations on separate PCBs. For example, in an implementation of the imaging device 200, the illumination LED source is provided as an off-axis illumination (i.e., has a central illumination axis that is not co-axial with the central FOV axis).

Referring to FIGS. 3A and 3B, an imaging assembly (e.g., the same as, similar to, or including the imaging assembly 245) is mounted in the handheld imaging device 300 (e.g., the same as, similar to, or including the imaging device 200 and/or handheld reader 100) and includes a depth camera (e.g., the same as, similar to, or including the imager 241) configured to capture depth image data of one or more objects appearing in a field of view (FOV) 316. While the objects are illustrated herein as various shapes, it will be understood that the techniques as described herein are not limited to specific forms of objects and can be implemented with regard to any objects for which the imaging device can capture imaging data. In FIGS. 3A and 3B, the one or more objects that are not among candidate objects are represented with dotted lines (e.g., object 310 and object 306 of FIG. 3A), the candidate objects are represented with dashed lines (e.g., object 302, object 312, and object 308 of FIG. 3A), and a highest ranked candidate object is represented with a solid line (e.g., object 304 of FIG. 3A). Although the highest ranked candidate object is not represented with a dashed line, the highest ranked candidate object may be part of the candidate objects. Further descriptions with regard to the objects as detailed above are described in greater detail below.

In some implementations, the imaging device 300 includes an aiming light source and an aiming lens for generating and directing a visible aiming light beam away from the handheld imaging device 300 and onto a surface in the direction of the FOV. The aiming light beam has a cross-section with a pattern, examples of which are shown in FIGS. 3A and 3B. Generally, FIGS. 3A and 3B depict a handheld imaging device 300, an imaging axis 317, the FOV 316 of the imaging assembly, and an aiming light pattern 314. In the exemplary embodiment of FIGS. 3A and 3B, the aiming light pattern 314 indicates the center of the FOV, namely the imaging axis 317. In particular, the aiming light pattern 314 bounds or surrounds the imaging axis 317, such that the aiming light is projected parallel to the imaging axis 317. Depending on the implementation, the aiming light is or is not colinear with the imaging axis 317. It will further be understood that the cross-sectional patterns depicted in FIGS. 3A and 3B are not exclusive, and other patterns may be projected onto an imaging plane using the disclosed aim light assembly techniques.

In FIG. 3A, the imaging device 300 including the depth camera can capture depth image data of the one or more objects appearing in the FOV 316. The depth image data can include a visual appearance of the one or more objects and distances of the one or more objects from the depth camera.

In some implementations, the depth camera can determine the distances of the one or more objects using phase data and amplitude data through a process based on the Time-of-Flight (ToF) principle. For example, the depth camera can emit a modulated light signal (e.g., an infrared light signal) that travels from the depth camera to the objects in the scene. When the light signal hits an object, the light signal reflects back to a sensor of the depth camera. By measuring the time that the light signal takes to travel to the object and back, the depth camera can determine the distance. The phase shift in the phase data (i.e., the difference in the position of the light wave cycles between the emitted and reflected light) is directly proportional to the distance the light has traveled. By accurately measuring the phase shift, the depth camera can calculate the precise distance to each point on the object's surface, thereby creating detailed depth image data (e.g., a depth map) of the FOV 316. The amplitude data can complement the phase data by providing information about the intensity of the reflected light signal. The amplitude indicates how much of the emitted light is reflected back to the camera, which can vary based on the object's surface properties and distance. Higher amplitude values are indicative of stronger reflections, often from closer or more reflective surfaces, while lower amplitude values may indicate weaker reflections from surfaces that are either farther away or less reflective. The depth camera (e.g., individually or in concert with a communicatively coupled computing device (not shown)) can use the amplitude information for filtering out noise and improving the accuracy of depth measurements. By analyzing both the phase shift and the amplitude of the reflected light, the depth camera can generate an accurate and reliable 3D representation of the FOV 316, ensuring that the depth image data is precise even in challenging conditions (e.g., objects of varying reflectivity, low light conditions, fast moving objects, etc.).

The imaging assembly can therefore capture the depth image data of the one or more objects 302, 304, 306, 308, 310, and/or 312 appearing in the FOV 316 using the depth camera. The one or more objects can be an object 302, an object 304, an object 306, an object 308, an object 310, and an object 312. The depth image data can comprise a depth map representing a 2D image where each pixel represents the distance from the camera to a corresponding surface (e.g., of the objects) in the scene. The intensity (e.g., brightness) of each pixel can correspond to the depth (e.g., distance) of the object from the depth camera. The high intensity pixels may represent that the object is close to the depth camera, while low intensity pixels may indicate that the object is far from the depth camera.

The imaging device 300 can identify or determine the one or more objects in the FOV 316 based on planar determinations (e.g., planar characteristics) of the one or more objects. The imaging device 300 can convert the depth image data to a point cloud. As used herein, a “point cloud” refers to a collection of data points in 3D space, where each point represents a specific location on the surface of an object. The points typically have coordinates (x, y, z) and can include additional attributes such as color and intensity. The imaging device 300 can then identify one or more planar regions of the one or more objects using a planar segmentation algorithm such as random sample consensus (RANSAC), region growing, etc. The imaging device 300 can then determine the planar determination representative of an object surface for an object of the one or more objects based on the one or more planar regions, and identify or determine the one or more objects based on the planar determinations in the FOV 316.

The imaging device 300 can detect one or more candidate objects of the one or more objects appearing in the field of view 316. In some implementations, the one or more candidate objects are objects that the imaging device 300 determines to be relevant and from which the imaging device 300 can determine a focus value. The imaging device 300 may determine that objects that are not in the one or more candidate objects are objects that the imaging device 300 will not determine the focus value from.

The imaging device 300 can determine the one or more candidate objects of the one or more objects using various techniques as described herein. In some implementations, the imaging device 300 determines the one or more candidate objects using the distance of the one or more objects. For example, the imaging device 300 can determine that the objects closest to the imaging device 300 are candidate objects. In further implementations, the imaging device 300 determines the one or more candidate objects is using the directionality (i.e., orientation) of the one or more objects. For example, the imaging device 300 can determine that the objects in the direction of (e.g., facing towards) the imaging device 300 are the candidate objects. In another example, the imaging device 300 can determine that the objects that are more orthogonal (e.g., more surface area) to the imaging device 300 to be candidate objects than the objects that are more parallel (e.g., less surface area). In still further implementations, the imaging device 300 determines the one or more candidate objects is using the position of the one or more objects. For example, the imaging device 300 can determine that objects that are closer to the center of the FOV 316 are candidate objects. In yet further implementations, the imaging device 300 determines the one or more candidate objects using a presence (or lack thereof) of an intersection between an aiming line (e.g., aiming light pattern 314) and the one or more objects. For example, the imaging device 300 can determine that objects that intersect with the aiming light pattern 314 are the candidate objects. In still yet further implementations, the imaging device 300 determines the one or more candidate objects using a contrast (e.g., determined from the depth image data) of the one or more objects. For example, the imaging device 300 can determine that objects with high contrasts (e.g., a barcode) are the one or more candidate objects. In another example, the imaging device 300 can determine that objects with uniform surface area (e.g., a surface area with less than a predetermined threshold of changes in reflected light and/or amplitude) have small contrasts, and therefore may not determine the objects as one or more candidate objects. In yet further implementations, the imaging device 300 determines the one or more candidate objects using the planar determination of the one or more objects. For example, the imaging device 300 can determine that an object with clearer planar features (e.g., larger surface areas, more reflective surfaces, or orientations that align well with the depth camera) are the one or more candidate objects. In some other implementations, the imaging device 300 may determine the one or more candidate objects using texture of the one or more objects. For example, the imaging device 300 may determine that an object with varying texture like a brick wall may result in different phase shifts and amplitudes that helps determine more accurate depth data, and therefore place the object with varying texture as the one or more candidate objects. Depending on the implementation, the imaging device 300 can utilize various techniques as described above, individually or in combination, to determine the one or more candidate objects.

The imaging device 300 can use the one or more techniques to determine that the objects 302, 304, 308, and 312 are candidate objects, and that the objects 306 and 310 are not candidate objects. Each candidate object in the one or more candidate objects can be associated with a candidate distance. The candidate distance can be a distance of the candidate object from the depth camera.

Upon determining the one or more candidate objects, the imaging device 300 can determine a ranking of the one or more candidate objects. In some implementations, the imaging device 300 uses the ranking to determine a focus target likelihood for each candidate object of the one or more candidate objects. Depending on the implementation, the ranking can be based on at least the candidate distance for each candidate object of the one or more candidate objects. For example, the imaging device can rank the candidate object that has smaller candidate distance, or the candidate object that is closer to the scanner, higher than the candidate object that has bigger candidate distance, or the candidate object that is away from the scanner. Additionally, the ranking of the one or more candidate objects may use the same techniques as when determining the candidate objects. For example, the ranking can be based on directionalities, positions, intersection of the aiming line, contrast from the depth image data, texture, and/or planar determination of the one or more candidate object.

In some embodiments, the imaging device 300 can use a two dimensional (2D) autofocus imaging assembly to capture 2D image data of the one or more objects. The imaging device 300 can then calibrate one or more metrics (e.g., directionalities, positions, etc.), at least some of the one or more metrics representative of positions of the one or more objects appearing in the field of view 316, based on the 2D image data and the depth image data to generate one or more calibrated metrics. After the calibration, each candidate distance for each candidate object of the one or more candidate objects can be determined or verified based on the one or more calibrated metrics.

The imaging device 300 may determine candidate scores of the one or more candidate objects to determine the ranking. The higher candidate scores can indicate higher ranking, while lower candidate scores can indicate lower ranking. In some implementations, the candidate scores are or include numerical scores indicating the ranking of the one or more candidate objects determined using the one or more techniques (e.g., candidate distances, directionalities, positions, etc.). For example, a candidate object with close distance and center of the field of view may have a higher ranking with a higher numerical score (e.g., 75, 80, 90, 100, etc.) while a candidate object with far distance and at the side of the field of view may have a lower numerical score (e.g., 25, 20, 15, 10, etc.). The candidate scores may be unitless metric without a maximum score (e.g., similar to measures of sharpness/contrast).

In some embodiments, the imaging device 300 may determine candidate scores of the one or more objects in the FOV 316 when determining the one or more candidate objects among the one or more objects. The imaging device 300 may then use the candidate scores to rank the one or more candidate objects instead of re-performing the one or more techniques to determine the ranking of the one or more candidate objects.

The imaging device 300 can determine that the object 304 has the highest candidate score, the object 302 has the second highest candidate score, the object 308 has the third highest candidate score, and the object 312 to has the smallest candidate score. Therefore, the object 304 can be determined to be the highest ranked candidate objects among the one or more candidate objects.

Upon determining the ranking of the one or more candidate objects, the imaging device 300 can automatically determine the initial focus value based on the ranking of the one or more candidate objects. The initial focus value may be based on the highest ranked candidate object (object 304).

FIG. 3B illustrates a scenario in which the highest ranked candidate object determined by the imaging device 300 in FIG. 3A is not a target object. For example, a user of the imaging device 300 attempted to focus on the object 302 (e.g., target object) but the imaging device 300 determines the highest ranked candidate object to be the object 304, and determines the initial focus value based on the object 304. When the highest ranked candidate object is not the target object, the imaging device 300 can determine a subsequent focus value. For example, the imaging device 300 can determine the subsequent focus value based on the object 302.

In FIG. 3B, the imaging device 300 may determine that the highest ranked candidate object is not a target object. In some implementations, the imaging device 300 may reference a pre-defined target object, such as a barcode, stored in its memory. This allows the device to compare the characteristics of the highest-ranked candidate object with the stored target object and identify discrepancies. In other implementations, the imaging device 300 may rely on user input to determine that the highest ranked candidate object is not a target object. A user operating the device can provide feedback indicating that the initial focus value was based on an incorrect object. This user input helps the imaging device 300 to re-evaluate its selection and refocus on the correct target object.

The imaging device 300, upon detecting the highest ranked candidate object is not the target object, may attempt to perform various autofocus techniques to focus on the highest ranked candidate object multiple times before determining to generate an updated ranking that excludes the highest ranked candidate object. For example, the imaging device 300 may capture a blurry version of the highest ranked candidate object, and therefore may attempt to remove blur (e.g., via incremental focus changes within a predetermined range) to determine whether the highest ranked candidate object is the target object. In another example, the imaging device 300 may focus on a wrong part of the highest ranked candidate object, and therefore may shift the focus to focus on nearby portions of the object to determine whether the highest ranked candidate object is the target object.

In some implementations, the imaging device 300 may attempt to make the highest ranked candidate object as clear as possible (e.g., because the object may be blurry) when determining the focus value. In another implementation, the imaging device 300 may use focus bracketing, moving tiny steps in different directions to make sure that the right part of the highest ranked candidate object is focused for the imaging device 300. Depending on the implementations, such techniques may ensure that the highest ranked candidate object is not the target object before generating the updated ranking.

The imaging device 300, upon determining that the highest ranked candidate object (e.g., object 304) is not the target object, automatically generates an updated ranking of the one or more candidate objects based on a remaining subset of the one or more candidate objects. The updated ranking, or the remaining subset, can exclude the highest ranked candidate object (object 304) from its ranking. Therefore, the updated ranking can comprise the same one or more candidate objects as in FIG. 3A except the object 304 (object 302, object 308, and the object 312). The object 304 is now represented with a dotted line, as the object 304 is no longer considered to be a candidate object. In some embodiments, the updated ranking may be determined among the one or more candidate objects by using the candidate scores already determined previously for the previous ranking of the one or more candidate objects in FIG. 3A. For example, the imaging device 300 can determine that the object 302 has the highest candidate score, the object 308 has the second highest candidate score, and the object 312 to has the smallest candidate score. Therefore, the object 302 can be determined to be the highest ranked candidate objects among the one or more candidate objects in the updated ranking.

In some embodiments, the updated ranking can depend on, be influenced by, and/or include a focus delta value indicative of a difference between the initial focus value and the subsequent focus value. For instance, the imaging device 300 may update the ranking of candidate objects based on the focus delta value. Specifically, the imaging device 300 may rank an object with a larger focus delta value from object 304 higher than an object with a smaller focus delta value.

As an illustrative example, the object 308 may be positioned far from the object 304, while the object 302 and object 310 may be located near the object 304. Because the object 308 is further from the object 304, the focus delta value between the object 308 and the object 304 may be greater than the focus delta values between the object 302 and the object 304, and the object 310 and the object 304. Therefore, the imaging device may rank the object 308 higher than the object 302 and the object 310.

In an alternative example, the object 302 may be positioned far from the object 304, while the object 308 and object 312 may be located near the object 304. Because the object 302 is further from the object 304, the focus delta value between the object 302 and the object 304 may be greater than the focus delta values between the object 308 and the object 304, and the object 312 and the object 304. Therefore, the imaging device may rank the object 302 higher than the object 312 and the object 308.

The imaging device 300 then determines the highest ranked candidate object from the updated ranking. The imaging device 300 can determine that the object 302 is the highest ranked candidate object from the updated ranking, and determine the subsequent focus value based on the object 302. If the imaging device 300 determines that the object 302 is not the target object, the imaging device 300 may repeat the process of updating the ranking until the highest ranked candidate object matches the target object. In some embodiments, the generating the updated ranking may be constrained by a predetermined time limit or a maximum number of attempts.

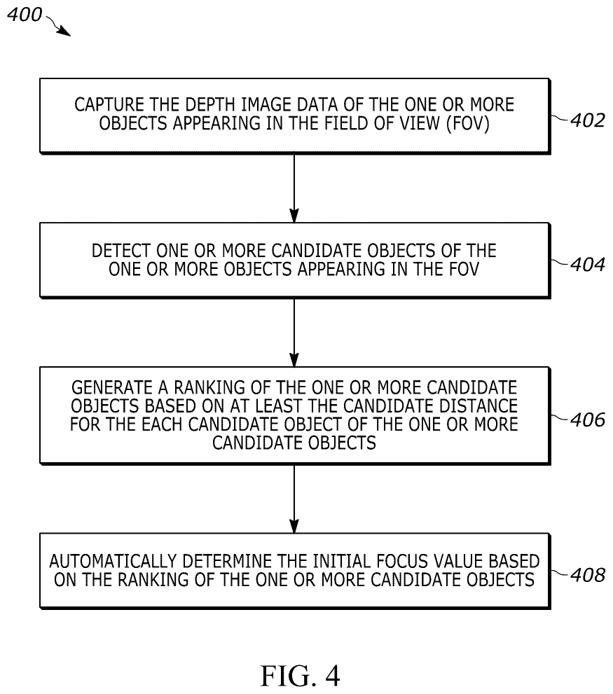

Referring next to FIG. 4, the method 400 illustrates a flow diagram of an example method for determining an initial focus value of an imaging device. Although the method 400 is described below with regard to an imaging device 200 and components thereof as illustrated in FIG. 2, it will be understood that other similarly suitable imaging devices and/or components may be used instead. The imaging device can include an imaging assembly including a depth camera and configured to capture depth image data of one or more objects appearing in a field of view (FOV).

At block 402, the imaging device can capture, via the imaging assembly, the depth image data of the one or more objects appearing in the FOV. The depth image data can comprise a depth map, which represents the distance from the imaging device to various points in the FOV. Each pixel in the depth map can correspond to a point in the FOV and has a depth value indicating how far that point is from the device. The data can provide and/or include a detailed spatial layout of the objects in the scene, enabling the imaging device to accurately determine the 3D structure and position of the objects, thereby supporting further analysis and object recognition processes.

The imaging device can identify or determine the one or more objects appearing in the FOV based on a planar determination of the one or more objects. The imaging device can determine the planar determination of the one or more objects by converting the depth image data to a point cloud. The imaging device can then identify one or more planar regions of the one or more objects using a planar segmentation algorithm. The imaging device can then determine a planar determination representative of an object surface for an object of the one or more objects based on the one or more planar regions, and identify or determine the one or more objects based on the planar determinations.

At block 404, the imaging device can detect one or more candidate objects of the one or more objects appearing in the FOV. The one or more candidate objects can be objects from which the imaging device will determine its focus value. For example, if the field of view 316 includes a crowded marketplace with numerous vendors and shoppers, the imaging device 300 may identify a vendor's stall and a prominently displayed product as the candidate objects. The device will then determine the focus value based on these selected objects. Objects not identified as candidate objects, such as the individual shoppers moving through the marketplace, will not be used to determine the focus value.

The imaging device can determine the one or more candidate objects based on one or more techniques including distance of the one or more objects, planar determination of the one or more objects, directionalities of the one or more objects representative of a direction an object is facing relative to the imaging device, position of the one or more objects, an intersection between an aiming line and the one or more objects, contrast from the depth image data of the one or more objects, texture of the one or more objects, and/or a planar determination of the one or more objects. Each candidate object of the one or more candidate objects can be associated with a candidate distance. Candidate distance may indicate distance of the candidate objects to the imaging device. Further descriptions of the one or more techniques are described with regard to FIG. 3A above.

At block 406, the imaging device can generate a ranking of the one or more candidate objects based on at least the candidate distance for each candidate object of the one or more candidate objects. The ranking can be indicative of a focus target likelihood for each candidate object of the one or more candidate objects. The imaging device can base the ranking of the one or more candidate objects on the directionalities of the one or more candidate objects representative of a direction an object is facing relative to the imaging device, position of the one or more candidate objects, an intersection between an aiming line and the one or more candidate objects, contrast from the depth image data of the one or more candidate objects, texture of the one or more candidate objects, and/or a planar determination of the one or more candidate objects, similar to determining the one or more candidate objects.

In some embodiments, the imaging device may weigh the one or more techniques used to determine the candidate objects and the ranking differently. For example, the imaging device may weigh the directionalities (i.e., orientation) of the one or more objects more than the intersection between an aiming line and the one or more objects.

In further embodiments, the imaging device can base the ranking on the one or more candidate scores of the one or more candidate objects. The imaging device can calculate the one or more candidate scores of the one or more candidate objects, which can represent numerical scores indicating the ranking of the one or more candidate objects determined using the one or more techniques (e.g., directionalities, positions, etc.).

In some other embodiments, the imaging device can calculate the candidate scores for the one or more objects when determining the one or more candidate objects and when ranking the one or more candidate objects.

In another embodiments, the imaging device 300 can comprise a two dimensional (2D) autofocus imaging assembly. The two dimensional autofocus imaging assembly can capture 2D image data of the one or more objects. The imaging device 300 can then calibrate one or more metrics, at least some of the one or more metrics representative of positions of the one or more objects appearing in the field of view 316, based on the 2D image data and the depth image data to generate one or more calibrated metrics. After the calibration, each candidate distance for each candidate object of the one or more candidate objects can be determined or verified based on the one or more calibrated metrics.

At block 408, the imaging device can automatically determine the initial focus value based on the ranking of the one or more candidate objects. The imaging device may determine the initial focus value based on a highest ranked candidate object.

In some embodiments, the imaging device may determine that the highest ranked candidate object is not a target object. For example, the imaging device (e.g., scanner) focuses on a reflective surface nearby while the target object is a barcode printed on a package. The imaging device 300, upon detecting the highest ranked candidate object is not the target object, may autofocus the highest ranked candidate object multiple times with different techniques before determining to generate an updated ranking that excludes the highest ranked candidate object (later described). For example, the imaging device 300 may attempt to make the highest ranked candidate object as clear as possible (e.g., because the object may be blurry or otherwise out of focus) when determining the focus value. In another embodiment, the imaging device 300 may use focus bracketing, moving small increments (e.g., by predetermined increments) in different directions to make sure that the right part of the highest ranked candidate object is focused for the imaging device 300. In some embodiments, the predetermined increments can vary depending on the type of the imaging device 300. The predetermined increments can be a value that is halfway between focus zones, or can be a value that is the smallest movement of the imaging device 300 that produces an optical change. For example, the predetermined increments can be diopter-based increments (e.g., 0.25 diopters), micrometer-based increments (e.g., 0.5 μm or 10 μm), and/or any other such increment. These different techniques may ensure that the highest ranked candidate object is not the target object before generating the updated ranking.

Upon determining that the candidate object is not a target object, the imaging device can automatically generate an updated ranking of the one or more candidate objects based on a remaining subset of the one or more candidate objects. The remaining subset may exclude the highest ranked candidate object. The imaging device can then determine a subsequent focus value based on the highest ranked candidate object of the updated ranking. The imaging device can base the updated ranking at least on a focus delta value indicative of a difference between the initial focus value and a subsequent focus value. The imaging device can constrain the automatically generating the updated ranking by a predetermined time limit or a maximum number of redeterminations in cases where the subsequent focus value is not focused on the target object. In some other cases, the imaging device can constrain the focus delta value by a maximum focus delta value.

The method for determining a focus value listed here has several benefits, especially in the field of machine vision. The method can enhance image clarity and sharpness by accurately setting the focus before image capture, leading to more reliable and precise analysis. The method therefore improves the performance of automated systems in applications such as quality control, where detecting particular components of an object is crucial. Additionally, the method facilitates better object recognition and classification by ensuring that visual features are clearly defined. By improving the initial focus determination, the method reduces the need for post-processing corrections, thus streamlining workflows and improving overall system efficiency in various machine vision tasks.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device configured to determine an initial focus value, the imaging device comprising:
one or more processors;
an imaging assembly including a depth camera and configured to capture depth image data of one or more objects appearing in a field of view (FOV); and
a computer-readable medium storing machine readable instructions that, when executed, cause the one or more processors to:
capture, via the imaging assembly, the depth image data of the one or more objects appearing in the FOV;
detect one or more candidate objects of the one or more objects appearing in the FOV, each candidate object of the one or more candidate objects being associated with a candidate distance;
generate a ranking of the one or more candidate objects based on at least the candidate distance for the each candidate object of the one or more candidate objects, the ranking indicative of a focus target likelihood for the each candidate object of the one or more candidate objects; and
automatically determine the initial focus value based on the ranking of the one or more candidate objects.

2. The imaging device of claim 1, wherein automatically determining the initial focus value is further based on a highest ranked candidate object.

3. The imaging device of claim 2, wherein the computer-readable medium further stores additional instructions that, when executed, cause the imaging device to:
determine that the highest ranked candidate object is not a target object; and
automatically generate an updated ranking of the one or more candidate objects based on a remaining subset of the one or more candidate objects, wherein the remaining subset excludes the highest ranked candidate object.

4. The imaging device of claim 3, wherein generating the updated ranking is based at least on a focus delta value indicative of a difference between the initial focus value and a subsequent focus value.

5. The imaging device of claim 3, wherein the automatically generating the updated ranking is constrained by a predetermined time limit or a maximum number of redeterminations.

6. The imaging device of claim 1, wherein the computer-readable medium further stores additional instructions that, when executed, cause the imaging device to:
calculate one or more candidate scores of the one or more candidate objects.

7. The imaging device of claim 6, wherein the ranking of the one or more candidate objects is further based on the one or more candidate scores of the one or more candidate objects.

8. The imaging device of claim 1, wherein the computer-readable medium further stores additional instructions that, when executed, cause the imaging device to:
convert the depth image data to a point cloud;
identify one or more planar regions of the one or more objects using a planar segmentation algorithm; and
determine a planar determination representative of an object surface for an object of the one or more objects based on the one or more planar regions.

9. The imaging device of claim 8, wherein the ranking of the one or more candidate objects is further based on the planar determination of the one or more candidate objects.

10. The imaging device of claim 1, wherein the ranking of the one or more candidate objects is further based on directionalities of the one or more candidate objects representative of a direction an object is facing relative to the imaging device.

11. The imaging device of claim 1, wherein the ranking of the one or more candidate objects is further based on position of the one or more candidate objects.

12. The imaging device of claim 1, wherein the ranking of the one or more candidate objects is further based on an intersection between an aiming line and the one or more candidate objects.

13. The imaging device of claim 1, wherein the ranking of the one or more candidate objects is further based on contrast from the depth image data of the one or more candidate objects.

14. The imaging device of claim 1, further comprising a two dimensional (2D) autofocus imaging assembly configured to:
capture, via the 2D autofocus imaging assembly, 2D image data of the one or more objects.

15. The imaging device of claim 14, wherein the computer-readable medium further stores additional instructions that, when executed, cause the imaging device to:
calibrate one or more metrics of the FOV, at least some of the one or more metrics representative of positions of the one or more objects appearing in the FOV, based on the 2D image data and the depth image data to generate one or more calibrated metrics.

16. The imaging device of claim 15, wherein the candidate distance for the each candidate object of the one or more candidate objects is determined based on the one or more calibrated metrics.

17. A method for determining an initial focus value of an imaging device, the method comprising:
capturing, by one or more processors via an imaging assembly, a depth image data of one or more objects appearing in a field of view (FOV);
detecting, by the one or more processors, one or more candidate objects of the one or more objects appearing in the FOV, each candidate object of the one or more candidate objects being associated with a candidate distance;
generating, by the one or more processors, a ranking of the one or more candidate objects based on at least the candidate distance for the each candidate object of the one or more candidate objects, the ranking indicative of a focus target likelihood for the each candidate object of the one or more candidate objects; and
automatically determining, by the one or more processors, the initial focus value based on the ranking of the one or more candidate objects.

18. The method of claim 17, wherein automatically determining the initial focus value is further based on a highest ranked candidate object.

19. The method of claim 18, wherein the method further comprises:
determining, by the one or more processors, that the highest ranked candidate object is not a target object; and
automatically generating, by the one or more processors, an updated ranking of the one or more candidate objects based on a remaining subset of the one or more candidate objects, wherein the remaining subset excludes the highest ranked candidate object.

20. The method of claim 19, wherein generating the updated ranking is based at least on a focus delta value indicative of a difference between the initial focus value and a subsequent focus value.
